(19) United States
(12) Patent Application Publication
(10) Pub. No.: US 2013/0267479 A1
(43) Pub. Date: Oct. 10, 2013

(54) Solutions Containing A Boron Complex, Method for Preparing Said Solutions, and Uses of Said Solutions

(71) Applicant: Frank Jamois, La Chapelle Des Fougeretz (FR)

(72) Inventor: Frank Jamois, La Chapelle Des Fougeretz (FR)

(73) Assignee: LABORATOIRES GOEMAR, Saint Malo Cedex (FR)

(21) Appl. No.: 13/993,191

(22) PCT Filed: Dec. 9, 2011
(86) PCT No.: PCT/FR11/52919

§ 371 Date: Jun. 11, 2013

(30) Foreign Application Priority Data
Dec. 13, 2010 (FR) 10 60439

(51) Int. Cl. C05C 11/00

(52) U.S. Cl. CPC C05C 11/00
USPC 514/64; 71/27; 252/182.12

(57) ABSTRACT

The present invention relates to solutions including at least one boron complex obtained through the reaction between at least one boron salt, consisting of a borate anion selected from within the group consisting of metaborate anions, tetraborate anions, pentaborate anions, octaborate anions, decaborate anions, and the mixtures thereof, and a cation selected from within the group including sodium cations, potassium cations, ammonium cations, and the mixtures thereof, and at least one polyol and at least one amino compound. The basic boron concentration is greater than 2 wt % of the total weight of the solution. The invention also relates to a method for preparing said solutions and to the uses of said solutions, particularly in the field of agriculture.

The present invention relates to solutions comprising at least one boron complex, to a process for preparing said solutions, and to uses thereof especially in the agricultural sector.

Boron is a trace element which is essential for plants. In particular, it engages in the metabolism of nucleic acids, the absorption and assimilation of cations, the formation of pectin in cell membranes, the absorption of water, the metabolism of carbohydrates, protein synthesis, and the setting of the fruits. It is also involved in the assimilation of phosphorus by the plant, and in the synthesis of vitamins of the B complex.

Boron is available to the plant in the form of boric acid, H₃BO₃. Calcareous clay soils and/or dry conditions limit the mobility of boron and hence increase the risks of deficiency.

Given that the amounts of boron necessary for optimum growth differ according to plant species, it is sometimes necessary to provide the plants with an external supply of boron.

Boric acid, though, has a low solubility in water (47.2 g/L at 20° C., or around 0.8% of elemental boron B).

Aqueous solutions of boric acid therefore have a low boron concentration.

Much research has been conducted into producing solutions which not only have a high boron concentration but are also stable over time.

It is well known that the mixing of boric acid with an alkanolamine, especially monoethanolamine, increases the boron concentration within aqueous solutions.

U.S. Pat. No. 5,614,653 describes an aqueous boron solution comprising boric acid, a water-soluble transition metal ion, and a ligand possessing two functional groups. The solution described in said patent contains from 9% to 13% by weight of boron and is said to be stable over time at room temperature, although the duration of stability is not specified.

However, although this solution is highly concentrated and evidently stable at room temperature, it employs transition metals such as Zn, Cu, Co or Ni which are not without risk from a toxicological and/or ecotoxicological and health standpoint and whose application cannot be justified from an agronomic standpoint. Indeed, it is well known that fertilizers based on trace elements are “to be used only in case of acknowledged need” and that the application rate “must not exceed the specified dose rate” as detailed in the obligatory labeling notifications of the fertilizers regulation CE 2003/2003.

Furthermore, boric acid is presently among the candidates on the list of substances subject to authorization as part of the REACH Regulation, as a substance of very high concern (SVHC). In the future, therefore, its use may be limited solely to certain applications.

It would therefore be an advantage to have stable, water-soluble solutions available that not only exhibit a high concentration of boron but also do not if possible exhibit any toxicity whatsoever.

Furthermore, it would be advantageous for these solutions to be stable over time not only at room temperature but also at temperatures which are representative of the storage conditions.

The Applicant has found that a solution comprising at least one boron complex obtained from a boron salt fulfills these requirements.

The invention accordingly provides a solution comprising at least one boron complex obtained by reaction of at least one boron salt—composed of a borate anion selected from the group consisting of metaborate anion, tetraborate anion, pentaborate anion, octaborate anion, decaborate anion, and mixtures thereof, and of a cation selected from the group consisting of sodium cation, potassium cation, ammonium cation and mixtures thereof—with at least one polyol and at least one amine compound.

The mass concentration of elemental boron within the solution according to the invention is greater than 2%, 3%, 4% and preferably is between 5% and 15%.

According to one particular embodiment, the above-described solution further comprises water.

The boron salt according to the invention may be present in its anhydrous or hydrated form and may exhibit different stoichiometries.

A “solution” is a homogeneous liquid obtained by complete dissolution of the boron complex.

An “amine compound” is a compound which has at least one amine function.

“Room temperature” is a temperature of between 18° C. and 23° C.

In the text below, the terms “glycerol” and “glycerin” will be used interchangeably to denote propane-1,2,3-triol.

The “%” are expressed by weight relative to the total weight of the solution.

Without being bound by any one theory, the inventors are of the opinion that the species employed and also the mechanism of formation of the boron complex present in the solution according to the invention are different from those which may be employed with boric acid. The combination of a polyol and of the amine compound with the boron salt allows the formation of at least one particular boron complex which has substantial stability and solubility, especially when they are mixed with other mineral salts or else with natural extracts, based on seaweed, for example, in the context of the production of products for agriculture.

According to one particular embodiment, the boron salt according to the invention is selected from the group consisting of disodium octaborate tetrahydrate, sodium tetraborate in anhydrous form or as pentahydrate or decahydrate, dipotassium tetraborate, dipotassium decaborate, diammonium decaborate, disodium decaborate (also called sodium pentaborate), sodium metaborate, and mixtures thereof.

The perborate does not form part of the boron salts which can be used according to the invention.

According to one preferred embodiment, the boron salt used is disodium octaborate tetrahydrate.

According to the invention, the polyol has the general formula (I) below

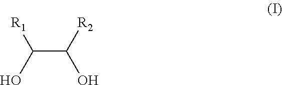

where R₁ and R₂ each represent, independently of one another, H or a linear or nonlinear carbon chain having one to six carbon atoms which may carry one or more alcohol or amine functions.

According to one particular embodiment, the polyol employed in the solutions according to the invention is selected from the group consisting of glycerol (propane-1,2,3-triol), ethylene glycol (ethane-1,2-diol), propylene glycol (propane-1,2-diol), butane-1,2-diol, butane-2,3-diol, butane-1,2,4-triol or mixtures thereof.

According to one preferred embodiment, the polyol is glycerol.

According to the invention, the amine compound is preferably selected from amino alcohols, diamines, and mixtures thereof.

According to one embodiment, the amino alcohol has the general formula (II) below

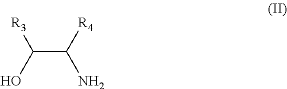

in which R₃, R₄ independently of one another each represent H or a linear or nonlinear carbon chain having one to six carbon atoms which may carry one or more alcohol or amine functions.

According to one particular embodiment, said amino alcohol is selected from the group consisting of ethanolamine (2-aminoethanol), diethanolamine, aminopropanol (1-amino-2-propanol or 2-amino-1-propanol), aminopropanediol (3-amino-1,2-propanediol or 2-amino-1,3-propanediol), aminobutanol, aminobutanediol, and mixtures thereof.

According to one preferred embodiment, the amino alcohol is ethanolamine.

According to one particular embodiment of the solutions of the invention, the diamine has the general formula (III) below

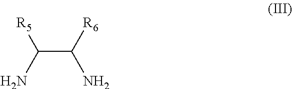

in which R₅ and R₆ each represent, independently of one another, H or a linear or nonlinear carbon chain of one to six carbon atoms which may carry one or more alcohol or amine functions.

Examples of such amines are those selected from the group consisting of ethylenediamine (1,2-diaminoethane), 1,2-diaminopropane, and mixtures thereof.

According to one preferred embodiment, the diamine is ethylene diamine.

Accordingly, the solutions of the present invention comprise complexing agents (polyol and amine compound) which are compatible industrially. The reason is that they do not have physicochemical properties (boiling point, flash point, flammability) or toxicological properties that make their use difficult to envisage, complicated, or even impossible industrially.

According to one particular embodiment, the solutions comprise:
from 10% to 90%, preferably from 15% to 80%, and more particularly from 20% to 50% of boron salt;
from 10% to 90%, preferably from 20% to 85%, and more preferably from 20% to 40% of polyol;
from 10% to 40%, preferably from 10% to 25% of amine compound.

According to one preferred embodiment, the relative proportions of borate species (boron salt) and of complexing agents are selected so as to promote complete and nonpartial complexing of the borate species.

According to another embodiment, the solutions comprise water in an amount of from 5% to 40%, preferably from 10% to 25%.

According to one preferred embodiment, the solutions comprise from 25% to 40% of disodium octaborate tetrahydrate, from 20% to 40% of glycerol, from 10% to 25% of ethanolamine and from 10% to 25% of water.

The invention further provides a process for preparing the solutions as described above, in other words solutions comprising at least one boron salt, at least one polyol, and at least one amine compound, and optionally water.

According to one embodiment, the preparation process comprises the following successive steps:

(a) preparing a solution containing at least one polyol and at least one amine compound;

(b) optionally adding water to the solution from the preceding step;

(c) adding at least one boron salt to said solution;

(d) stirring the mixture obtained in the preceding step until dissolution is complete.

The stirring time will depend on the components selected and will be easily determined by the skilled person. It will be such that dissolution is complete.

For the purpose of accelerating the reaction, it is preferable for the mixture composed of the boron salt(s), the polyol(s) and the amine compound(s) to be heated at a temperature of between 40° C. and 90° C., preferably between 70° C. and 85° C.

According to one preferred embodiment, the mixture is heated at a temperature of 80° C.

The solutions obtained according to the processes described above are clear solutions, in other words solutions in which all of the boron has dissolved.

Without wishing to be tied by any one theory, the reason for this is that the inventors are of the opinion that the presence of a polyol and of an amine compound within the solution according to the invention allows not only an increase in the solubility of the boron in water, by formation of at least one particular boron complex, but also an increase in the stability of the resulting solutions.

These boron-rich solutions exhibit very high stability over time across a broad temperature range: from −20° C. to 50° C.

These solutions, indeed, are stable for at least one month at 50° C., at least three months at 40° C., at least six months at room temperature, and at least 12 months at 4° C. and at −20° C.

Lastly, the invention additionally provides for the use of the solutions according to the invention, especially in the agricultural sector. These solutions are miscible with water in any proportions and therefore, for example, may be readily applied by foliar spraying to target trees and crops, following dilution.

They may also be incorporated as admixture with other mineral salts for a supply of primary/major fertilizing elements (nitrogen, phosphorus, potassium) and/or secondary fertilizing elements (magnesium, calcium, sodium, sulfur) and/or trace elements (cobalt, copper, iron, manganese, molybdenum, zinc) in the context of fertilizer formulation, and have the particular feature especially of being compatible with seaweed-based fertilizers and/or natural extracts, which is generally not the case with other boron complexes.

The solutions according to the invention may also be used for the manufacture of fertilizer, of fertilizing material, of growth medium, and of plant health products.

Furthermore, the solutions according to the invention may be used in the treatment of metals and/or as a biocide in the treatment of wood.

The present invention will be illustrated by the examples which follow and which are in no way limitative.

### EXAMPLES

### Example 1

A solution containing 300 g of glycerin, 200 g of monoethanolamine and 250 g of water is prepared beforehand with vigorous stirring. When the mixture is entirely homogeneous, 250 g of disodium octaborate tetrahydrate are added and the mixture is heated at 80° C. for two hours with vigorous stirring. Return to room temperature gives a solution containing 5.2% of boron B.

### Example 2

A solution containing 300 g of glycerin, 200 g of monoethanolamine and 100 g of water is prepared beforehand with vigorous stirring. When the mixture is entirely homogeneous, 400 g of disodium octaborate tetrahydrate are added and the mixture is heated at 80° C. for two hours with vigorous stirring. Return to room temperature gives a solution containing 8.4% of boron B.

### Example 3

A solution containing 300 g of ethylene glycol, 200 g of monoethanolamine and 200 g of water is prepared beforehand with vigorous stirring. When the mixture is entirely homogeneous, 300 g of disodium octaborate tetrahydrate are added and the mixture is heated at 80° C. for three hours with vigorous stirring. Return to room temperature gives a composition containing 6.3% of boron B.

### Example 4

A solution containing 200 g of glycerin, 100 g of ethylene glycol, 200 g of monoethanolamine and 150 g of water is prepared beforehand with vigorous stirring. When the mixture is entirely homogeneous, 350 g of disodium octaborate tetrahydrate are added and the mixture is heated at 80° C. for two hours with vigorous stirring. Return to room temperature gives a solution containing 7.3% of boron B.

### Example 5

A solution containing 300 g of glycerol, 200 g of monoethanolamine and 200 g of water is prepared beforehand with vigorous stirring. When the mixture is entirely homogeneous, 300 g of disodium octaborate tetrahydrate are added and the mixture is heated at 80° C. for three hours with vigorous stirring. Return to room temperature gives a composition containing 6.3% of boron B.

The solutions obtained in examples 1 to 5 remain clear after storage for at least one month at 50° C., at least three months at 40° C., at least six months at room temperature, and at least 12 months at 4° C. and at −20° C.

### Comparative Examples 2, 3, and 4

### Study of Stability in the Absence of Amine Compound

The solutions described in examples 2, 3, and 4 were produced by replacing the monoethanolamine with water or with a polyol.

The stability of the solutions thus produced was studied, and the results are collated in the table below.

TABLE 1
Study of stability of solutions without amine compound

| | Example reproduced by | |
|---|---|---|
| | replacing the amount | |
| | of monoethanolamine | Observations |
| Comparative | Example 2, | Crystallization |
| example 2-1 | replacing the | after one day at |
| | monoethanolamine | room temperature |
| | with 200 g of water | |
| Comparative | Example 2, | Start of |
| example 2-2 | replacing the | crystallization |
| | monoethanolamine | between two weeks |
| | with 200 g of glycerin | and one month at |
| | | room temperature, |
| | | at 5° C. and at −20° C. |
| Comparative | Example 3, | Crystallization |
| example 3 | replacing the | after one day at |
| | monoethanolamine | room temperature |
| | with 200 g of water | |
| Comparative | Example 4, | Crystallization |
| example 4 | replacing the | after one day at |
| | monoethanolamine | room temperature |
| | with 200 g of water | |

These results show that the solution is less stable when it does not contain amine compound.

### Example 6

### Comparison of Stability of a Solution Obtained from Boric Acid with a Solution Obtained According to One of Examples 1 to 5

A solution containing 60% by weight of boric acid, 20% by weight of ethanolamine and 20% by weight of water relative to the total weight of the solution is prepared. This solution is referenced solution A and has a concentration of 10% by weight of elemental boron.

Solution B corresponds to that prepared in example 1.
Solution C corresponds to that prepared in example 2.
Solution D corresponds to that prepared in example 3.
Solution E corresponds to that prepared in example 4.
Solution F corresponds to that prepared in example 5.

Solutions A, B, C, D, E and F are stored at 50° C.

Solution A precipitates in less than a week, whereas the solutions according to the invention, in other words solutions B, C, D, E and F are still stable after one month of storage at 50° C.

The solutions according to the invention exhibit better stability than the solutions based on boric acid at 50° C.

### Example 7

### Study of Stability of Solutions Comprising a Boron Salt Introduced into an Aqueous Solution of Mineral Salts

The solution described in document U.S. Pat. No. 4,610,881 (column 3), whose formulation is given below, was produced.

### Composition of Solution A

40% w/w octaborate
51% ethylene glycol
9% water

Said solution A was introduced into two aqueous compositions (COMP1 and COMP2) of mineral salts which also comprised seaweed extracts.

A solution according to the invention as prepared according to example 5 was also introduced into the two compositions COMP1 and COMP2.

The compositions comprising the solution as prepared according to example 5 exhibit stability of more than one year at −20° C. and at 40° C. and of more than three years at room temperature, whereas those comprising solution A crystallize after two weeks in a very pronounced way at room temperature and at −20° C.

These results demonstrate very high compatibility of the solutions according to the invention in aqueous compositions of mineral salts comprising seaweed extracts.

### Example 8

### Study of Stability of a Solution Comprising Boric Acid

The solution described in U.S. Pat. No. 4,844,725 (example column 3), whose formulation is given below, was produced.

### Composition of Solution B

24.3% w/w n-hexylamine
8% propylene glycol
51.7% boric acid
16% water

In simply a few days, solution B crystallizes at room temperature, at 5° C., and at −20° C.

1. A solution comprising at least one boron complex obtained by reaction of at least one boron salt—composed of a borate anion selected from the group consisting of metaborate anion, tetraborate anion, pentaborate anion, octaborate anion, decaborate anion, and mixtures thereof, and of a cation selected from the group consisting of sodium cation, potassium cation, ammonium cation and mixtures thereof—with at least one polyol and at least one amine compound, the concentration of elemental boron being greater than 2% by weight of the total weight of the solution.

2. The solution as claimed in claim 1, wherein the amine compound is selected from the group consisting of amino alcohols of general formula (II), diamines of general formula (III), and mixtures thereof; 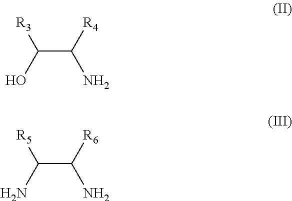
in which R₃, R₄, R₅ and R₆ each represent, independently of one another, H or a linear or nonlinear carbon chain of 1 to 6 carbon atoms which may carry one or more alcohol or amine functions.

3. The solution as claimed in claim 1, wherein it further comprises water.

4. A boron solution as claimed in claim 1, wherein the boron salt is selected from the group consisting of disodium octaborate tetrahydrate, sodium tetraborate in anhydrous form or as pentahydrate or decahydrate, dipotassium tetraborate, dipotassium decaborate, diammonium decaborate, disodium decaborate, sodium metaborate, and mixtures thereof.

5. The solution as claimed in of claim 1, wherein the polyol has the general formula (I) 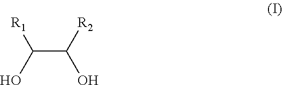
in which R₁ and R₂ each represent, independently of one another, H or a linear or nonlinear carbon chain of 1 to 6 carbon atoms which may carry one or more alcohol or amine functions.

6. The solution as claimed in claim 5, wherein the polyol is selected from the group consisting of glycerol (propane-1,2,3-triol), ethylene glycol (ethane-1,2-diol), propylene glycol (propane-1,2-diol), butane-1,2-diol, butane-2,3-diol, butane-1,2,4-triol, and mixtures thereof.

7. The solution as claimed in claim 2, wherein the amino alcohol is selected from the group consisting of ethanolamine (2-aminoethanol), diethanolamine, aminopropanol (1-amino-2-propanol or 2-amino-1-propanol), aminopropanediol (3-amino-1,2-propanediol or 2-amino-1,3-propanediol), aminobutanol, aminobutanediol, and mixtures thereof.

8. A boron solution as claimed in claim 2, wherein the diamine is selected from the group consisting of ethylenediamine (1,2-diaminoethane), 1,2-diaminopropane, and mixtures thereof.

9. The solution as claimed in of claim 1, wherein it comprises:
from 10 to 90% by weight of boron salt, relative to the total weight of the solution;
from 10 to 90%, by weight of polyol relative to the total weight of the solution;
from 10 to 40% by weight of amine compound, relative to the total weight of the solution.

10. The solution as claimed in claim 3, wherein the concentration of water is between 5 and 40% by weight of the total weight of the solution.

11. The solution as claimed in claim 1, wherein it is stable for at least one month at 50° C., at least three months at 40° C., at least six months at room temperature, and at least 12 months at 4° C. and at −20° C.

12. A process for preparing a solution as claimed in claim 1, comprising the following successive steps:
(a) preparing a solution containing at least one polyol and at least one amine compound;
(b) optionally adding water to the solution from the preceding step;
(c) adding at least one boron salt to said solution;
(d) stirring the mixture obtained in the preceding step until dissolution is complete.

13. The process as claimed in claim 12, wherein the stirring may be carried out at temperatures of between 40° C. and 90° C.,

14. (canceled)

15. A method for manufacturing a fertilizer, fertilizing material, growth medium, or plant health products comprising the step of applying the solution of claim 1 to target trees and crops.

16. The method as claimed in claim 15, wherein the solution is admixed with other mineral salts in fertilizer formulation.

17. A method for treating metals comprising the step of applying the solution of claim 1 to metals.

18. A method for treating wood comprising the step of applying the solution of claim 1 to wood.

19. A method for manufacturing a fertilizer, fertilizing material, growth medium, or plant health products comprising the step of applying the solution prepared by the process of claim 12 to target trees and crops.

20. A method for treating metals comprising the step of applying the solution prepared by the process of claim 12 to metals.

21. A method for treating wood comprising the step of applying the solution prepared by the process of claim 12 to wood.
